(19) United States
(12) Patent Application Publication
(10) Pub. No.: US 2014/0078326 A1
(43) Pub. Date: Mar. 20, 2014

(54) FOCUS CONTROL DEVICE, METHOD FOR CONTROLLING FOCUS AND IMAGE PICKUP APPARATUS

(71) Applicant: Sony Corporation, Tokyo (JP)

(72) Inventors: Jun Ozawa, Tokyo (JP); Eiji Shintaku, Tokyo (JP); Ryuji Watanabe, Kanagawa (JP); Kazuhito Taneoka, Saitama (JP); Mamoru Sugiura, Kanagawa (JP)

(73) Assignee: SONY CORPORATION, Tokyo (JP)

(21) Appl. No.: 14/018,881

(22) Filed: Sep. 5, 2013

(30) Foreign Application Priority Data
Sep. 14, 2012 (JP) 2012-202470

(51) Int. Cl. G03B 3/10; H04N 5/232

(52) U.S. Cl. CPC G03B 3/10; H04N 5/23287
USPC 348/208.5; 359/754

(57) ABSTRACT

A focus control device includes a first focus-lens group, a second focus-lens group, a wobbling control unit that generates a first wobbling control signal used to control a wobbling motion of the first focus-lens group and generates a second wobbling control signal used to control a wobbling motion of the second focus-lens group, and a phase control unit that controls the phase of the first and second wobbling control signals, wherein the phase control unit corrects the phase of the first wobbling control signal to cause the first focus-lens group to make a first target wobbling motion and corrects the phase of the second wobbling control signal to cause the second focus-lens group to make a second target wobbling motion.

### BACKGROUND

The present disclosure relates to a focus control device, a method for controlling focus and an image pickup apparatus.

Image pickup apparatuses, typified by digital cameras and digital video cameras, are widely used. The image pickup apparatuses generally employ a mechanism in which an image is formed on an image pickup device, such as charge coupled device (CCD) and complementary metal oxide semiconductor (CMOS), to obtain electrical signals. These image pickup apparatuses are equipped with an autofocus function for automatically focusing on a subject. Japanese Unexamined Patent Application Publication No. 2011-242791 describes a technology for determining a focus position by independently performing different control operations on a main focus-lens group and a sub focus-lens group.

### SUMMARY

Since the technology described in the publication independently performs different control operations on the main focus-lens group and the sub focus-lens group, the main focus-lens group and sub focus-lens group may not keep an optimal distance therebetween. Consequently, deterioration of exposure efficiency (focusing performance) for signal detection, variation in an angle of view, and aberration occur, and therefore poor-looking moving images are recorded.

Accordingly it is desirable to provide a focus control device, a method for controlling focus and an image pickup apparatus that can maintain an appropriate distance between focus-lens groups (hereinafter, sometimes appropriately referred to as “group-to-group distance”).

According to an embodiment of the present disclosure, there is provided, for example, a focus control device including: a first focus-lens group; a second focus-lens group; a wobbling control unit that generates a first wobbling control signal used to control a wobbling motion of the first focus-lens group and generates a second wobbling control signal used to control a wobbling motion of the second focus-lens group; and a phase control unit that controls the phase of the first wobbling control signal and the phase of the second wobbling control signal, wherein the phase control unit corrects the phase of the first wobbling control signal to cause the first focus-lens group to make a first target wobbling motion and corrects the phase of the second wobbling control signal to cause the second focus-lens group to make a second target wobbling motion.

According to the embodiment of the present disclosure, there is provided, for example, a method for controlling focus in a focus control device, including: generating a first wobbling control signal used to control a wobbling motion of a first focus-lens group; generating a second wobbling control signal used to control a wobbling motion of a second focus-lens group; controlling the phase of the first wobbling control signal and the phase of the second wobbling control signal; correcting the phase of the first wobbling control signal to cause the first focus-lens group to make a first target wobbling motion; and correcting the phase of the second wobbling control signal to cause the second focus-lens group to make a second target wobbling motion.

According to the embodiment of the present disclosure, there is provided, for example, an image pickup apparatus including: an image pickup unit; a first focus-lens group; a second focus-lens group; a wobbling control unit that generates a first wobbling control signal used to control a wobbling motion of the first focus-lens group and generates a second wobbling control signal used to control a wobbling motion of the second focus-lens group; and a phase control unit that controls the phase of the first wobbling control signal and the phase of the second wobbling control signal, wherein a detection area is set in order to perform a focus evaluation on an image signal captured by an image pickup unit, the phase control unit corrects the phase of the first wobbling control signal to cause the first focus-lens group to make a first target wobbling motion and corrects the phase of the second wobbling control signal to cause the second focus-lens group to make a second target wobbling motion, and the first target wobbling motion and the second target wobbling motion are motions set such that centers of periods of sections of the wobbling motions substantially coincide with an exposure period of a central pixel in the detection area.

According to another embodiment of the present disclosure, there is provided, for example, a focus control device including: a first focus-lens group; a second focus-lens group; a wobbling control unit that generates a first wobbling control signal used to control a wobbling motion of the first focus-lens group and generates a second wobbling control signal used to control a wobbling motion of the second focus-lens group; and a phase control unit that controls the phase of the first wobbling control signal and the phase of the second wobbling control signal, wherein the phase control unit corrects the phase of the first wobbling control signal to cause the first focus-lens group to make a first target wobbling motion and corrects the phase of the second wobbling control signal for the second focus-lens group so as to cause the second focus-lens group to follow the wobbling motion of the first focus-lens group based on the first wobbling control signal.

According to the embodiment of the present disclosure, there is provided, for example, a method for controlling focus in a focus control device, including: generating a first wobbling control signal used to control a wobbling motion of a first focus-lens group; generating a second wobbling control signal used to control a wobbling motion of a second focus-lens group; controlling the phase of the first wobbling control signal and the phase of the second wobbling control signal; correcting the phase of the first wobbling control signal to cause the first focus-lens group to make a first target wobbling motion; and correcting the phase of the second wobbling control signal for the second focus-lens group so as to cause the second focus-lens group to follow the wobbling motion of the first focus-lens group based on the first wobbling control signal.

At least one embodiment of the present disclosure can maintain an appropriate distance between the first focus-lens group and the second focus-lens group.

### BRIEF DESCRIPTION OF THE DRAWINGS

FIG. 1 illustrates an example of a CCDAF method.

FIG. 2 is a block diagram showing an example of a configuration of an image pickup apparatus.

FIG. 3 illustrates an example of functions of a processor.

FIG. 4 illustrates an example of motions according to the first embodiment.

FIG. 5A illustrates a problem associated with variation in group-to-group distance, while FIG. 5B illustrates an example of effects achieved by the first embodiment of the disclosure.

FIG. 6 is a flowchart for describing a process flow according to the first embodiment.

FIG. 7 illustrates an example of motions according to the second embodiment.

FIG. 8 is a flowchart for describing a process flow according to the second embodiment.

### DETAILED DESCRIPTION OF EMBODIMENTS

With reference to the drawings, embodiments of the present disclosure will be described below. The description will be given in the following order.
1. First Embodiment
2. Second Embodiment
3. Modification

Note that the following embodiments and modification are merely preferred examples and are not intended to limit the features of this disclosure thereto.

### 1. First Embodiment

### Method for Controlling Autofocus Functions

For the purpose of making this disclosure easy to understand, the description will begin with an example of a method for controlling autofocus functions. A predominantly used method for controlling autofocus functions is, for example, a method, so-called a CCDAF method, of calculating a focus-evaluation value from the contrast, high frequency components or other factors extracted from a detection area of an image pickup apparatus and then adjusting the position of a focus lens so that the calculated focus value reaches its highest level.

The focus-evaluation value in relation to the position of the focus lens reaches its maximum when the focus lens is placed at a focus position. Thus, controlling the position of the focus lens so as to obtain the maximum focus-evaluation value can achieve autofocus. To determine in which direction the focus lens should be moved to reach the focus position, a motion, called wobbling, is made. Wobbling is performed to vibrate the focus lens slightly but not enough to affect images, thereby obtaining a variation component (differential component dy/dx) of the focus-evaluation values.

In wobbling, a focus lens is first moved a certain distance in a direction away from the image pickup device during a first period, and then is stopped for a certain period of time during a second period. Then, the focus lens is moved a certain distance in a direction closer to the image pickup device during a third period, and then is stopped for a certain period of time during a fourth period. This series of operations from the first period to the fourth period is repeated. The first to fourth periods (irrespective of the order) are defined as a wobbling cycle.

A focus-evaluation value is detected in each of the second period and fourth period and the difference between the values is calculated to obtain a variation component of the focus-evaluation values (i.e., differential component dy/dx) produced by wobbling. The direction in which the focus lens is to be moved to reach the focus position is determined by assessing whether the variation component is positive or negative.

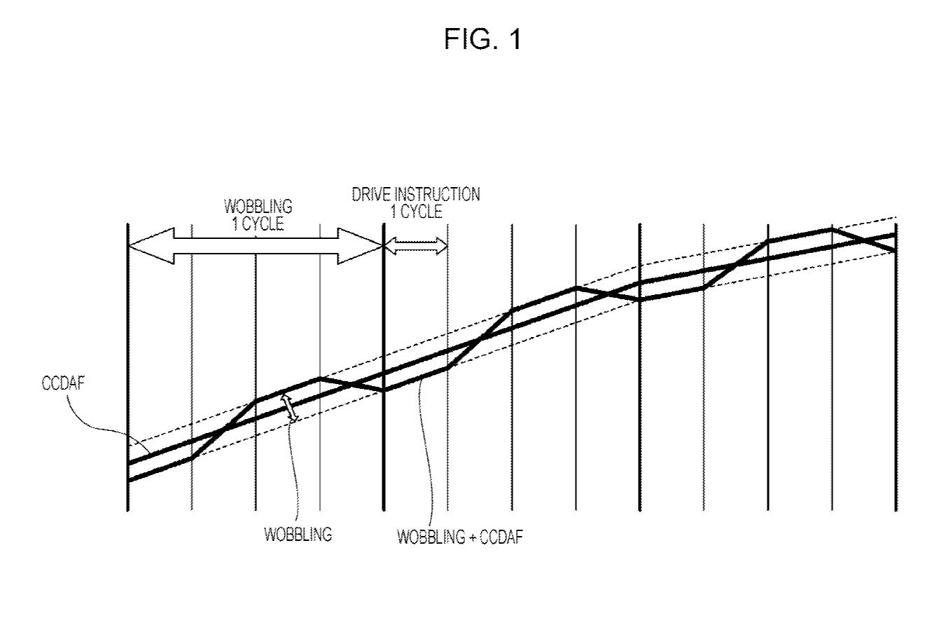

As schematically shown in FIG. 1, the focus lens is controlled in the CCDAF method and undergoes a wobbling motion. Operations for controlling the timing at which focus-evaluation values are acquired, controlling the movement of lenses, instructing for driving and some other operations are performed at a timing corresponding to, for example, one field or one frame. In this embodiment, these operations are supposed to be executed at a timing corresponding to one frame.

In control of the CCDAF method, the aforementioned wobbling motion can prevent the lens from hunting in the vicinity of the focus position. However, since the cycle of the wobbling motion is short, a delay in driving the focus lens or the like may possibly be not corrected in time. In addition, it is difficult for focus lens groups each including focus lenses different in size and number to be corrected in such a way as to make the driving variations uniform. In order to solve the problem, in an example of this disclosure, a plurality of focus-lens groups all undergo a wobbling motion to produce the same target drive motion. An example of the present disclosure will be described in detail below.

### [Configuration of Image Pickup Apparatus]

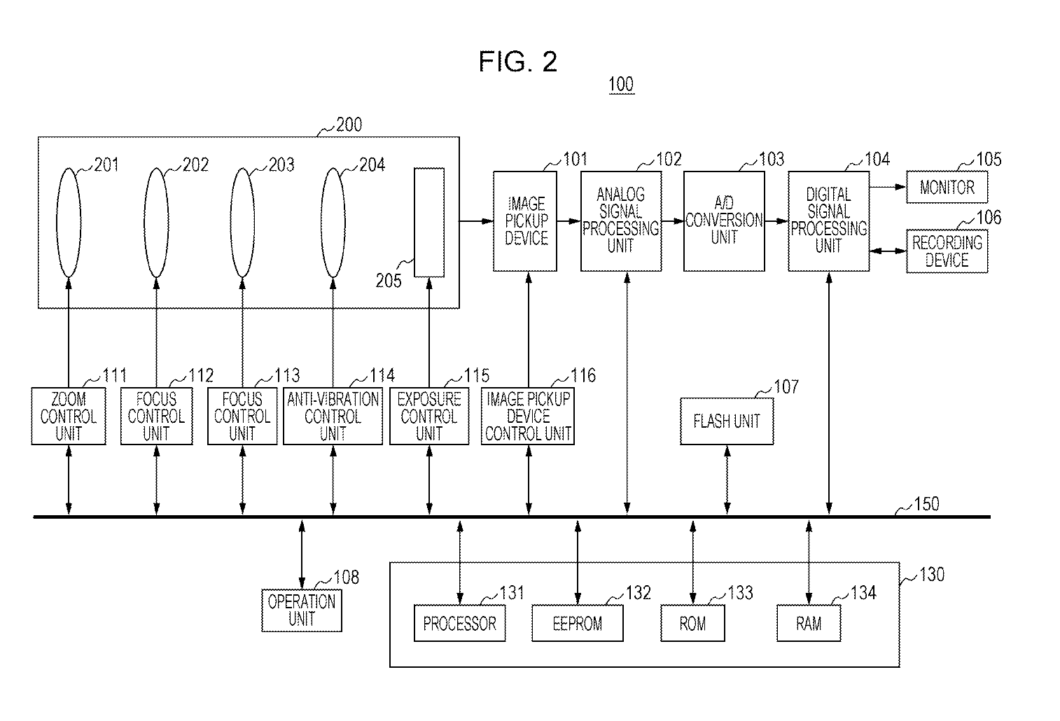

FIG. 2 is a block diagram showing the configuration of an image pickup apparatus 100 according to the first embodiment. The image pickup apparatus 100 is, for example, a digital still camera, digital video camera or the like having a function of capturing moving images. As shown in FIG. 2, the image pickup apparatus 100 includes an image pickup device 101, an analog signal processing unit 102, an analog to digital (A/D) conversion unit 103, a digital signal processing unit 104, a monitor 105, a recording device 106, a flash unit 107 and an operation unit 108. The image pickup apparatus 100 further includes a control unit 130 and a lens block 200. The control unit 130 includes a processor 131, an electrically erasable programmable read-only memory (EEPROM) 132, a read only memory (ROM) 133 and a random access memory (RAM) 134.

The lens block 200 includes a zoom lens 201, a first focus-lens group 202, a second focus-lens group 203, an anti-vibration lens 204 and a diaphragm (including a shutter) 205 that adjusts exposure. The image pickup apparatus 100 further includes a control mechanism that controls each component of the lens block 200 and the image pickup device 101. More specifically, the image pickup apparatus 100 includes a zoom control unit 111 that controls the zoom lens 201, a focus control unit 112 that controls the focus-lens group 202, a focus control unit 113 that controls the focus-lens group 203, an anti-vibration control unit 114 that controls the anti-vibration lens 204, an exposure control unit 115 that controls the diaphragm 205 and an image pickup device control unit 116 that controls the image pickup device 101.

The components of the control unit 130 and image pickup apparatus 100 are connected with each other via a bus 150. The following are descriptions of the components.

The lens block 200 is used to form an image of a subject on an imaging surface of the image pickup device 101. The lenses constituting the lens block 200 are aligned substantially in a line along the optical axis of light from the subject (referred to as subject light as is appropriate). The term, “substantially in a line”, denotes an arrangement that allows light having passed through the lens block 200 to enter the image pickup device 101. Therefore, the centers of the lenses and the center of the image pickup device 101 do not have to be arranged collinearly. The lens block 200 can include a mirror device that partially reflects the subject light in a predetermined direction.

Moving the zoom lens 201 in the direction of the optical axis allows zooming in and out on a subject in an adjustable manner. Likewise, moving the focus-lens group 202 and focus-lens group 203 in the direction of the optical axis allows focusing on the subject in an adjustable manner. Each focus-lens group 202 and focus-lens group 203 includes one or more lenses. Although the lens block 200 includes two focus-lens groups in this embodiment, it can include three or more focus-lens groups.

The anti-vibration lens 204 is a lens used to correct camera shake. Correction information used to correct camera shake is generated based on sensor information provided by an angular velocity sensor (not shown). For example, the control unit 130 generates correction information. The correction information is supplied to the anti-vibration control unit 114 that in turn controls the anti-vibration lens 204 so that the anti-vibration lens 204 actuates for camera shake correction. The diaphragm 205 adjusts the amount of subject light to be incident on the image pickup device 101.

The image pickup device 101, which is an example of an image pickup unit, is, for example, a sensor in which pixels are arranged two-dimensionally. The image pickup device 101 and the subsequent analog/digital signal processing units 102, 104 may be regarded as an image pickup unit. A CMOS image sensor that performs exposure at a different timing for each pixel is an illustrative example of the image pickup device 101. Of course, a CCD can be used for the image pickup device 101.

The image pickup device 101 picks up an image of a subject in synchronization with a period of a vertical sync signal and performs photoelectric conversion on the subject's optical image which is made incident thereon via the lens block 200 and primary-color filter (omitted from FIG. 2) provided in front of the image pickup device 101 to generate an imaging signal. The image pickup device 101 outputs the generated imaging signal to the analog signal processing unit 102. The image pickup device 101 performs some processes, including an imaging-signal generating process, under control of the image pickup device control unit 116. For example, the image pickup device 101 generates an imaging signal at a timing instructed by the image pickup device control unit 116. Alternatively, the image pickup device 101 can be configured to move under control of the image pickup device control unit 116 to correct camera shake.

The analog signal processing unit 102 performs a correlated double sampling (CDS) process on analog image data fed from the image pickup device 101 to improve the signal to noise (S/N) ratio. Furthermore, the analog signal processing unit 102 performs an automatic gain control (AGC) process to control the gain. The analog image data subjected to the analog signal process by the analog signal processing unit 102 is fed to the A/D conversion unit 103. The A/D conversion unit 103 converts the analog image data into digital image data. The digital image data is fed to the digital signal processing unit 104.

The digital signal processing unit 104 includes, for example, a digital signal processor (DSP). The digital signal processing unit 104 performs predetermined digital image processing. Exemplary digital image processing includes YC-separation processing, white balance processing, interpolation processing, gamma correction processing, color correction processing, edge enhancement processing, tone reproduction processing, noise reduction processing and so on. A luminance signal Y separated by YC-separation processing is fed via the bus 150 to the processor 131 of the control unit 130.

The image data having been subjected to processing by the digital signal processing unit 104 is fed to, for example, the monitor 105 that in turn displays an image based on the image data. The monitor 105 includes a display panel, such as an liquid crystal display (LCD) panel and an organic electroluminescence (EL) panel, and a driver for driving the display panel. In addition to the image data, the monitor 105 displays a menu through which various settings of the image pickup apparatus 100 are set, and other items.

The image data having been subjected to processing by the digital signal processing unit 104 is fed to, for example, the recording device 106 that in turn stores the image data. If the image data is moving image data, the image data having been subjected to processing by the digital signal processing unit 104 is compressed into a compression-encoding format, such as AVCHD (Advanced Video Codec High Definition) (Trademark), and stored in the recording device 106. If the image pickup apparatus 100 can pick up still images, the still image data is compressed into a compression-encoding format, such as JPEG (Joint Photographic Experts Group), and stored in the recording device 106.

The recording device 106 is at least one of a recording device built into the image pickup apparatus 100 and a recording device detachably mounted in the image pickup apparatus 100. An exemplary recording device 106 may be a hard disk, a flash memory, an optical disk, a magneto-optical disk and so on. Image data obtained by shooting is stored in the recording device 106 under control of the digital signal processing unit 104. For example, users can select which of the internal memory or external memory is used to store the image data on the basis of a user's wishes.

The flash unit 107 is, for example, a nonvolatile memory. The flash unit 107 stores setting information of the image pickup apparatus 100 and so on.

Buttons, dials, switches and so on provided on the image pickup apparatus 100 are collectively called an operation unit 108. In response to manipulations performed by users on the operation unit 108, various settings of the image pickup apparatus 100 and imaging operations are set. The aforementioned monitor 105 may be a touchscreen functioning as the operation unit 108.

The control unit 130 controls each component of the image pickup apparatus 100 and includes, for example, a processor 131, such as a central processing unit (CPU), an EEPROM 132, a ROM 133 and a RAM 134. The processor 131 performs computations and control operations to control each component of the image pickup apparatus 100. The EEPROM 132 and RAM 134 are used as a working area allocated for operations performed by the processor 131 and as a temporary data storage area. The EEPROM 132 stores, for example, positional information and drive motion history of the focus-lens group 202 and the other group supplied from the focus control unit 112 and focus control unit 113. The ROM 133 stores, for example, programs to be executed by the processor 131.

The processor 131 of the control unit 130 generates control signals to control each lens of the lens block 200. The processor 131 generates, for example, zoom-lens control signals to control the zoom lens 201. The control unit 130 further generates focus-lens control signals to control the focus-lens group 202 and focus-lens group 203. The focus-lens control signal includes, for example, a movement control signal used to control the movement of the focus lenses except for wobbling motions and a wobbling control signal used to control wobbling motions of the focus lenses.

The control system for the lens block 200 will be described. The zoom control unit 111 includes, for example, a drive mechanism, such as a stepping motor, that drives the zoom lens 201, and a microcomputer. The microcomputer is capable of communicating with the processor 131 via the bus 150. For instance, the processor 131 feeds zoom-lens control signals to the microcomputer of the zoom control unit 111 through the communication. The drive mechanism of the zoom control unit 111 is actuated in response to the zoom-lens control signal to move the zoom lens 201 to a position in accordance with the zoom-lens control signal. In addition, the zoom control unit 111 feeds the positional information of the zoom lens 201 to the processor 131 through the communication.

The focus control unit 112 includes, for example, a drive mechanism, such as a stepping motor, that drives the focus-lens group 202, and a microcomputer. The microcomputer is capable of communicating with the processor 131 via the bus 150. For instance, the focus control unit 112 feeds positional information of the focus-lens group 202 to the processor 131 through communication.

The processor 131 feeds movement control signals and wobbling control signals to the microcomputer of the focus control unit 112 through communication. The focus control unit 112 moves the focus-lens group 202 to a predetermined position in accordance with a focus-lens control signal. Furthermore, the focus control unit 112 causes the focus-lens group 202 to wobble in response to the wobbling control signal.

The focus control unit 113 includes, for example, a drive mechanism, such as a stepping motor, that drives the focus-lens group 203, and a microcomputer. The microcomputer is capable of communicating with the processor 131 via the bus 150. For instance, the focus control unit 113 feeds positional information of the focus-lens group 203 to the processor 131 through communication.

The processor 131 feeds movement control signals and wobbling control signals to the microcomputer of the focus control unit 113 through communication. The focus control unit 113 moves the focus-lens group 203 to a predetermined position in accordance with a focus-lens control signal. Furthermore, the focus control unit 113 causes the focus-lens group 203 to wobble in response to the wobbling control signal.

The anti-vibration control unit 114 moves the anti-vibration lens 204 based on correction information fed by the processor 131. Movement of the anti-vibration lens 204 in a predetermined direction optically corrects camera shake.

The exposure control unit 115 controls the aperture and shutter included in the diaphragm 205 so that the diaphragm 205 opens and closes. The aperture value and shutter speed are appropriately controlled according to the brightness of the subject. This control is performed by, for example, the processor 131. The processor 131 feeds an exposure control signal to the exposure control unit 115 that controls the diaphragm 205 so that the diaphragm 205 has an appropriate aperture and shutter speed.

The image pickup device control unit 116 controls the image pickup device 101. Under control of the image pickup device control unit 116, the image pickup device 101 generates an imaging signal by performing photoelectric conversion on an optical image of a subject which is made incident thereon via the lens block 200 and a primary-color filter and an electronic shutter is actuated. Camera shake may be corrected by the image pickup device control unit 116 that appropriately controls the position of the image pickup device 101 in response to the control performed by the processor 131.

### [Example of Processor Functions]

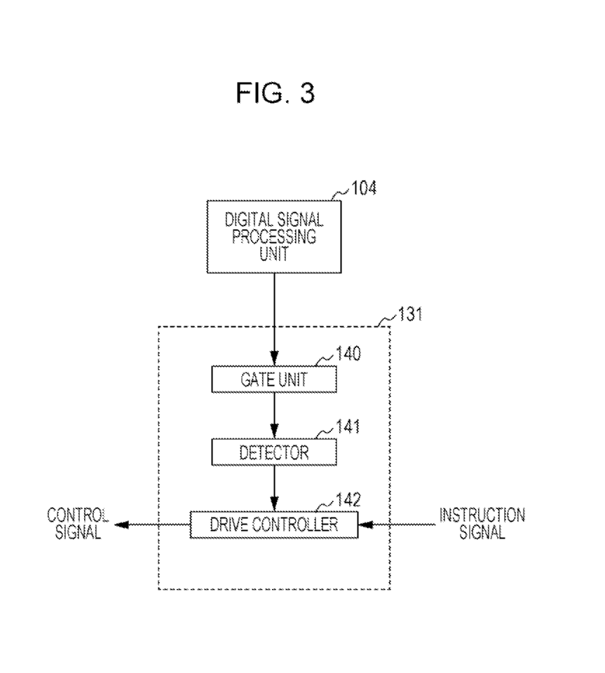

FIG. 3 illustrates an example of functions of the processor 131. The functions shown in FIG. 3 are merely some of functions of the processor 131, and the processor 131 has various functions to control each component of the image pickup apparatus 100. In FIG. 3, the bus 150 and some other components are omitted. The processor 131 includes, for example, a gate unit 140, a detector 141 and a drive controller 142 to implement the functions.

A luminance signal Y that is a separated signal obtained through YC-separation processing in the digital signal processing unit 104 is input into the gate unit 140 of the processor 131. The gate unit 140 extracts only signals obtained from a detection area, which is preset within a screen, based on the luminance signal Y transmitted from the digital signal processing unit 104. The gate unit 140 outputs the extracted signal to the detector 141.

The detector 141 extracts a high-frequency component from the signal input by the gate unit 140, performs rectification and detection on the high-frequency component, and performs calculation to determine a focus-evaluation value necessary for autofocus control. The detector 141 outputs the determined focus-evaluation value to the drive controller 142.

The drive controller 142 generates control signals for the control units of the respective lenses and the image pickup device control unit. The drive controller 142 calculates the movement amount of the focus-lens group 202 and focus-lens group 203 based on the focus-evaluation value. In addition, the drive controller 142 generates wobbling control signals for the focus-lens group 202 and focus-lens group 203. In short, the processor 131 including the drive controller 142 functions as a wobbling control unit. Furthermore, the drive controller 142 generates movement control signals used to control the movement of the focus lenses caused by motions other than a wobbling motion.

Furthermore, the drive controller 142 changes at least a phase of the wobbling control signals and movement control signals. In short, the processor 131 including the drive controller 142 functions as a phase control unit. Also the drive controller 142 can be configured to control the amplitude of the wobbling control signals and movement control signals.

The drive controller 142 can also be configured to generate focus-lens control signals and zoom-lens control signals based on, for example, a manual-focus instruction signal, a zoom instruction signal, a manual/autofocus-switch signal and other signals input through the operation unit 108.

An example of a configuration of the image pickup apparatus 100 has been described so far. The image pickup apparatus 100 achieves autofocus by automatically setting the focus-lens group 202 and focus-lens group 203 in the focus positions based on the focus-evaluation value calculated by the detector 141. Autofocusing can be implemented by employing, for example, a CCDAF method. In the CCDAF method, the focus position is calculated from the focus-evaluation value, and wobbling takes place to identify the directions in which the focus-lens group 202 and focus-lens group 203 are to be moved to the focus positions.

### [CCDAF Control Method]

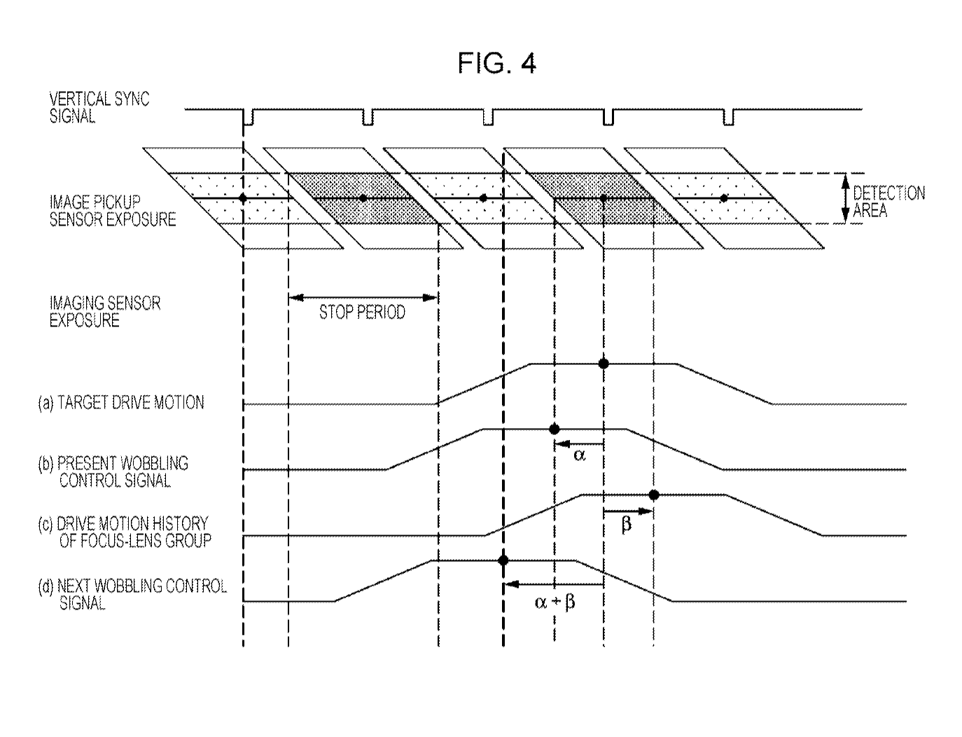

With reference to FIG. 4, a CCDAF control method according to the first embodiment will be described. In CCDAF, the focus lens may move with motions other than a wobbling motion; however, FIG. 4 shows only wobbling components out of the motions.

As shown in FIG. 4, a detection area is set for an imaging signal obtained by the image pickup device 101. Generally, subjects at the center are often regarded as important, and therefore the detection area is often set in the vicinity of the center of the imaging signal. During a period in which the detection area, particularly a central pixel in the detection area, is exposed to light to evaluate the focal point for autofocusing, it is preferred not to wobble the focus-lens group 202 in order to localize an exact focus position.

In addition, the focus-lens group 202 is set to be driven with good exposure efficiency. Good exposure efficiency herein means that an exposure period in which the central pixel in the detection area is exposed to light with the greatest amplitude coincides with or substantially coincides with the center of a period of a section of wobbling motions, specifically, the center of a stop period of the focus-lens group 202 during a series of wobbling motions. Substantially coinciding means that a time difference between the center of the exposure period and the center of a period of a section of the wobbling motions is smaller than a threshold. Coinciding or substantially coinciding of the exposure period of the central pixel in the detection area and the center of the stop period of the focus-lens group 202 may be collectively called “substantially coinciding”.

The exposure period varies according to brightness and some other factors; however, the drive controller 142 can identify the exposure period and the center of the exposure period along the center line of the detection area based on brightness control information used to control an iris and shutter speed and the position and size of the detection area.

Part (A) of FIG. 4 illustrates a drive motion of the focus-lens group with the highest exposure efficiency (appropriately referred to as “target drive motion”). Part (B) of FIG. 4 illustrates a present wobbling control signal for the focus-lens group 202. If the focus-lens group 202 makes a wobbling motion match the target drive motion, the phase shift amount of the wobbling control signal is 0. However, the wobbling motion of the focus-lens group 202 may be shifted from the target drive motion due to control delay, shooting environments, age deterioration of components and other various factors. For the purpose of correcting the shift, the phase of the wobbling control signal is corrected. For example, a present wobbling control signal shown in Part (B) of FIG. 4 has a phase shifted by a with respect to the target drive motion to correct a delay in driving the focus-lens group 202.

Part (C) of FIG. 4 shows drive motion history of the focus-lens group 202 when the focus-lens group 202 wobbled based on the wobbling control signal shown in Part (B) of FIG. 4. If the focus-lens group 202 is driven in response to the wobbling control signal in Part (B) of FIG. 4, for example, the focus-lens group 202 is delayed in moving by β with respect to the target drive motion. Comparison between the target drive motion and the actual drive motion of the focus-lens group 202 is made by, for example, performing comparison of timings at the center of the stop period of the focus-lens group 202. Alternatively, the position of the focus-lens group 202 can be compared with the position indicated by the target drive motion every time the drive motion history is acquired.

The delay of the focus-lens group 202 with respect to the target drive motion demonstrates that the phase shift amount (α) of the wobbling control signal is not appropriate. To correct the shift amount, the phase of the next wobbling control signal is shifted by β equivalent to the drive motion delay. Specifically, the phase of the next wobbling control signal is shifted by (α+β) with respect to the target drive. The focus-lens group 202 wobbles in response to the wobbling control signal with a phase shift amount of (α+β) as shown in Part (D) of FIG. 4.

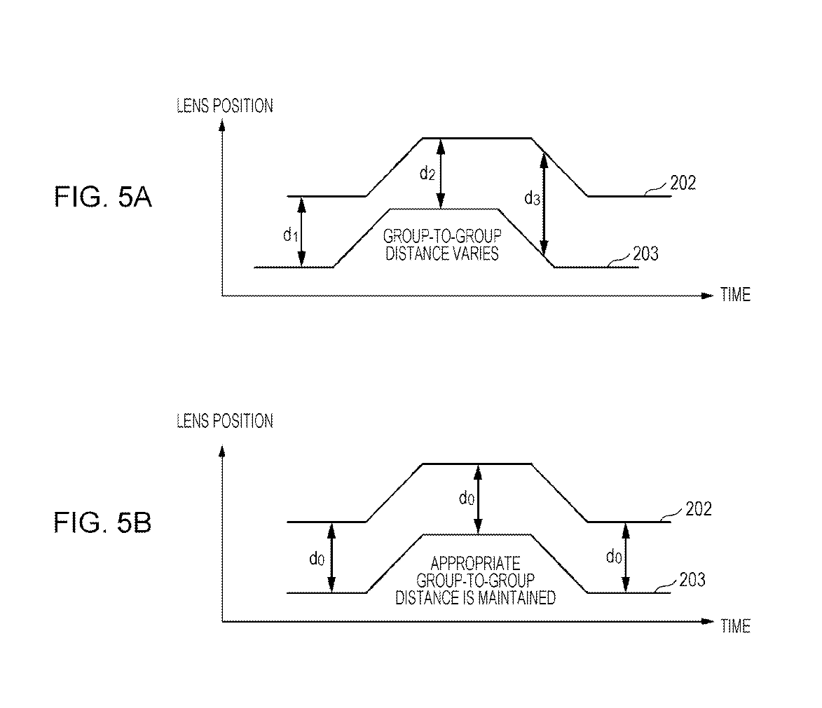

The aforementioned control can allow the focus-lens group 202 to make a wobbling motion matching the target drive motion. As shown in FIG. 5A, control made for only some of the focus-lens groups (e.g., focus-lens group 202) produces differences in distance between the focus-lens groups as shown by distance d₁, d₂, d₃. However, the aforementioned control is exercised on each of the focus lenses constituting the focus-lens group 202 and each of the focus lenses constituting the focus-lens group 203. In other words, every focus lens is driven so as to achieve the target drive motion. Thus, as shown in FIG. 5B, an appropriate group-to-group distance (d₀) can be maintained and variations in an angle of view and aberration caused by variations of the group-to-group distance can be prevented.

### [Process Flow of the First Embodiment]

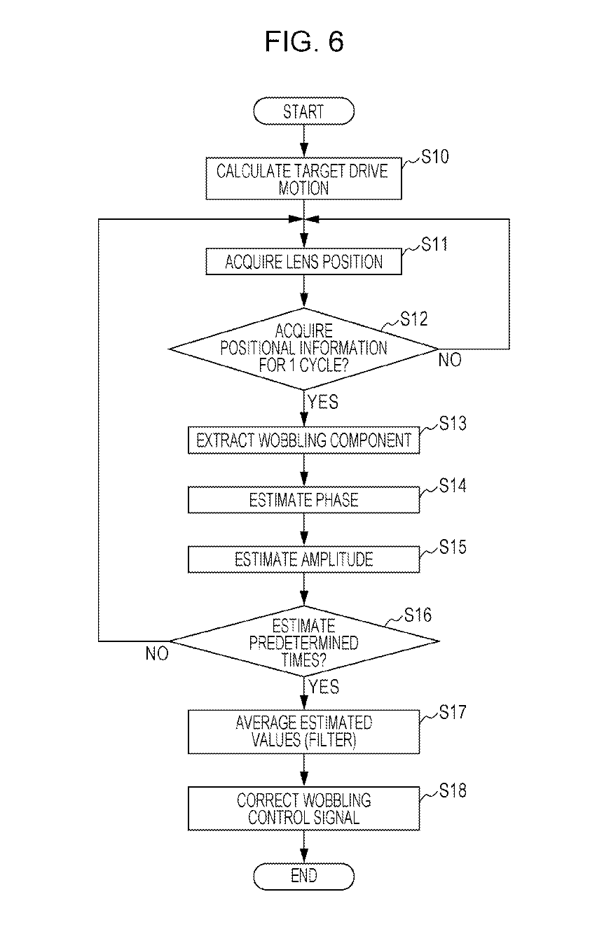

With reference to the flowchart in FIG. 6, a process flow according to the first embodiment will be described. Processes, which will be described in the following description, are executed by the processor 131 unless otherwise noted.

In step S10, a target drive motion of the focus-lens group 202 is calculated. For instance, the processor 131 determines an exposure period and an exposure period of a central pixel in a detection area based on brightness control information used to control an iris and shutter speed and the position and size of the detection area. Then, the process goes to Step S11.

In step S11, the processor 131 acquires the positional information of the focus-lens group 202. The positional information indicative of the position of the focus-lens group 202 is fed from the focus control unit 112 to the processor 131. The positional information of the focus-lens group 202 is acquired, for example, one frame at a time. Instead of a one-frame unit, the positional information of the focus-lens group 202 can be acquired at predetermined intervals. The acquired positional information of the focus-lens group 202 is stored in the EEPROM 132 as a drive motion history. Then, the process goes to Step S12.

In step S12, it is determined whether the positional information of the focus-lens group 202 for one cycle of a wobbling motion has been acquired. If the positional information of the focus-lens group 202 for one cycle of the wobbling motion has not been acquired, the process returns to step S11. If the positional information of the focus-lens group 202 for one cycle of the wobbling motion has been acquired, the process goes to step S13.

The focus-lens group 202 moves with the wobbling motion as well as motions other than the wobbling motion (e.g., CCDAF motion). In step S13, a movement component relating to the wobbling motion and a movement component relating to the other motions are separated from each other to extract the movement component relating to the wobbling motion. Then, the process goes to step S14 and step S15.

In steps S14 and S15, the phase and amplitude of the wobbling are estimated based on the wobbling component extracted in step S13 and the drive motion history of the focus-lens group 202 is acquired. Then, the process goes to step S16. In step S16, the processes from step S11 to step S15 are repeated a predetermined number of times, and it is determined whether the phase and amplitude of the wobbling have been estimated a predetermined number of times. Although the processes from step S11 to step S15 are repeated a plurality of times for the purpose of enhancing process reliability, it may not be necessary to perform the processes a plurality of times. The number of times the processes are performed is appropriately set to achieve improved process reliability. After the processes from step S11 to step S15 have been performed a predetermined number of times, the process goes to step S17.

In step S17, the estimated values of phase and amplitude, which are obtained through the predetermined number of times of performing the processes, are averaged using a filter or the like. The average values of the phase and amplitude are stored in, for example, the EEPROM 132. Then, the process goes to step S18. In step S18, it is determined whether and how much the phase of the drive motion the focus-lens group 202 has actually made is shifted from the phase of the target drive motion. In order to correct the determined shift, the phase of the present wobbling control signal is shifted by a predetermined shift amount to correct the wobbling control signal. The corrected wobbling control signal is fed to the focus control unit 112. The focus control unit 112 is actuated based on the wobbling control signal to allow the focus-lens group 202 to perform a wobbling motion. The processes shown in FIG. 6 are performed a plurality of times while autofocusing is being controlled. The processes shown in FIG. 6 are performed, for example, on a cycle basis.

Similar processes from step S10 to step S18 are performed on the respective focus lenses constituting the focus-lens group 203. For instance, when a moving image is taken, the focus-lens group 202 and focus-lens group 203 perform a wobbling motion. The focus-lens group 202 and focus-lens group 203 make a drive motion that coincides with or substantially coincides with the target drive motion. The respective focus-lens groups that make a drive motion matching the target drive motion can maintain an appropriate distance therebetween. Although the target drive motions for the focus-lens group 202 and focus-lens group 203 are set to be the same in this example, different target drive motions can be set for them.

### 2. Second Embodiment

Next, the second embodiment will be described. The image pickup apparatus according to the second embodiment is, for example, configured in the same manner as the image pickup apparatus 100 that appeared in the description of the first embodiment, and therefore the same description is not repeated.

### [Summary of the Second Embodiment]

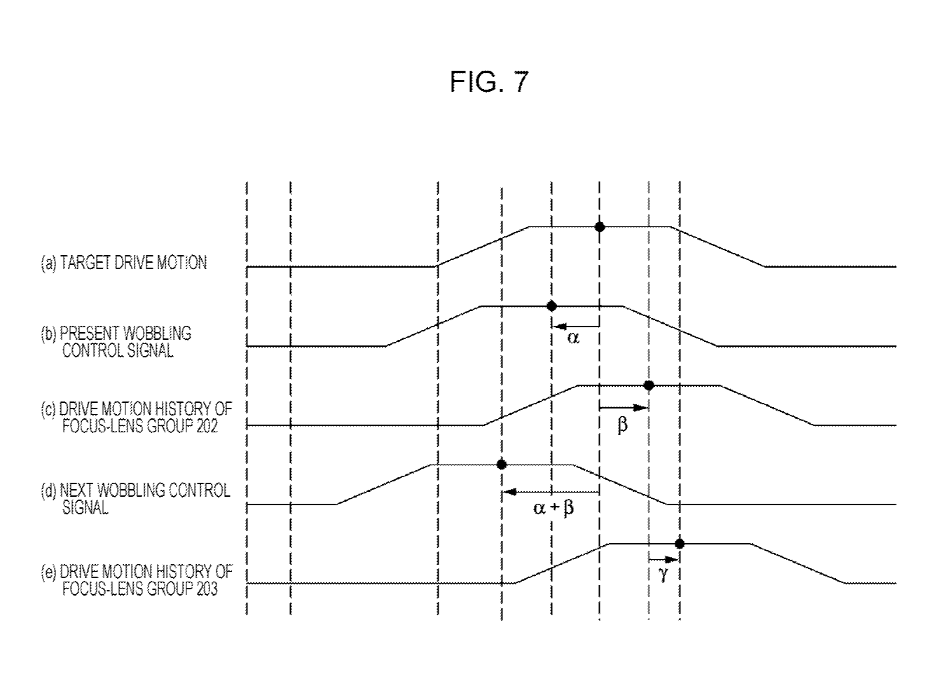

With reference to FIG. 7, a brief description about processes of the second embodiment will be made. As shown in FIG. 7, the same processes are preformed on the focus-lens group 202 as those of the first embodiment. In sum, the shift of a present drive motion of the focus-lens group 202 with respect to the target drive motion is estimated, and the phase of a wobbling control signal for the focus-lens group 202 is adjusted based on the estimated result (Parts (A) to (D) of FIG. 7). In addition, a wobbling control signal for the focus-lens group 203 is corrected so that the focus-lens group 203 follows the actual drive motion of the focus-lens group 202.

In FIG. 7, comparison between the drive motion history of the focus-lens group 202 shown in Part (C) and the drive motion history of the focus-lens group 203 shown in Part (E) shows a shift 7 in phase. When the shift is zero, the correlation between the drive motion history (waveform) in Part (C) and the drive motion history (waveform) in Part (D) becomes the maximum. To achieve the maximum correlation value, the phase of the wobbling control signal for the focus-lens group 203 is shifted. In this example, the phase shift amount of the wobbling control signal for the focus-lens group 203 is set to γ.

Through the processes described in the first embodiment, the delay in drive motion and the over or short amount of the drive motion of the focus-lens group 202 are corrected so as to drive the focus-lens group 202 to match the target drive motion. If the focus-lens group 202 and focus-lens group 203 have the same target drive motions, the focus-lens group 203 is driven so as to follow the drive motion of the focus-lens group 202, thereby controlling the drive motion of the focus-lens group 203 to match the target drive motion. Controlling the focus-lens group 202 and focus-lens group 203 so as to match their target drive motions allows the focus-lens group 202 and focus-lens group 203 to maintain an appropriate distance therebetween.

### [Process Flow of the Second Embodiment]

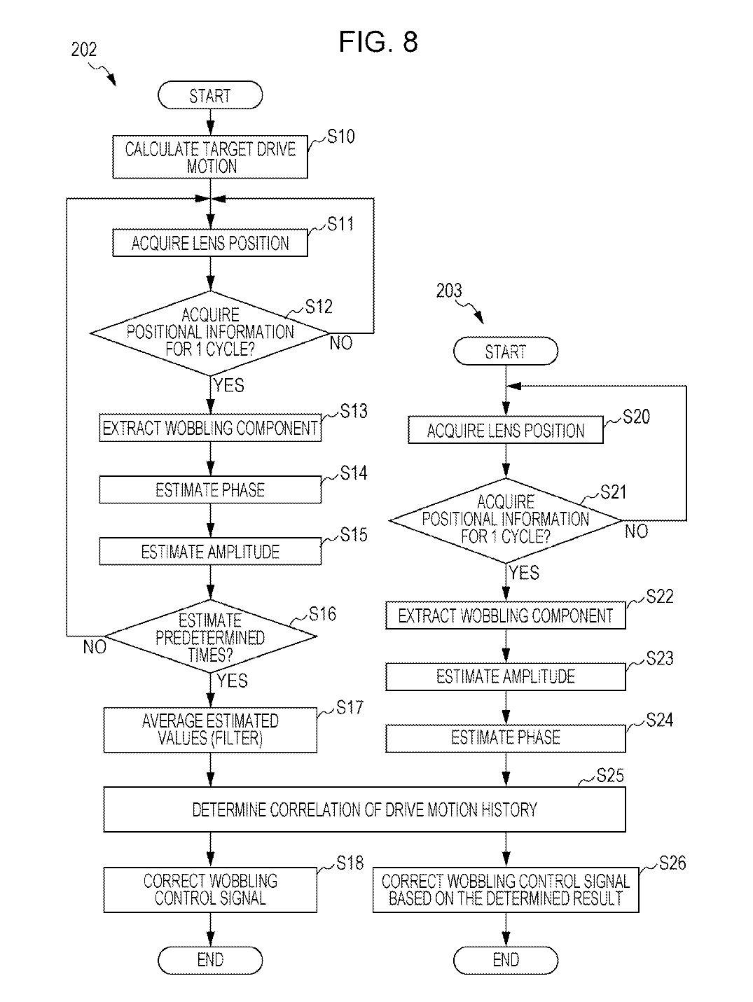

With reference to the flowchart in FIG. 8, processes according to the second embodiment will be described. The processes to be performed on the focus-lens group 202 (from step S10 to step S18) are the same as those of the first embodiment, and therefore the same description is not repeated.

Roughly the same processes are performed on the focus-lens group 203 as those performed on the focus-lens group 202. In step S21, the processor 131 acquires the positional information of the focus-lens group 203. The positional information indicative of the position of the focus-lens group 203 is fed from the focus control unit 113 to the processor 131. The positional information of the focus-lens group 203 is acquired, for example, one frame at a time. Instead of a one-frame unit, the positional information of the focus-lens group 203 can be acquired at predetermined intervals. The acquired positional information of the focus-lens group 203 is stored in the EEPROM 132 as a drive motion history. Then, the process goes to step S22.

In step S22, it is determined whether the positional information of the focus-lens group 203 for one cycle of a wobbling motion has been acquired. If the positional information of the focus-lens group 203 for one cycle of the wobbling motion has not been acquired, the process returns to step S20. If the positional information of the focus-lens group 203 for one cycle of the wobbling motion has been acquired, the process goes to step S22.

The focus-lens group 203 moves with the wobbling motion as well as motions other than the wobbling motion (e.g., CCDAF motion). In step S22, a movement component relating to the wobbling motion and a movement component relating to the other motions are separated from each other to extract the movement component relating to the wobbling motion. Then, the process goes to step S23 and step S24.

In steps S23 and S24, the phase and amplitude of the wobbling are estimated based on the wobbling component extracted in step S22. As with the case of the focus-lens group 202, the processes from step S20 to step S24 may be repeated a plurality of times for the purpose of enhancing process reliability. The amplitude and phase, which are obtained through the predetermined number of times of performing the processes, may be averaged. Then, the process goes to step S25.

In Step 25, the processes from step S11 to step S18 performed on the focus-lens group 202 determine the drive motion history of the focus-lens group 202 (Part (C) of FIG. 7). On the other hand, the processes from step S20 to step S24 performed on the focus-lens group 203 determine the drive motion history of the focus-lens group 203 (Part (E) of FIG. 7). In step S25, the drive motion history of the focus-lens group 202 is compared with the drive motion history of the focus-lens group 203 to determine their correlation. Then, the process goes to step S26.

In step S26, a wobbling control signal for the focus-lens group 203 is corrected so as to increase the correlation determined in step S25. For instance, to achieve the highest correlation, in other words, to cause the focus-lens group 203 to perform a wobbling motion so as to follow the wobbling motion of the focus-lens group 202, the wobbling control signal for the focus-lens group 203 is corrected. The corrected wobbling control signal is fed to the focus control unit 113. The focus control unit 113 is actuated based on the fed wobbling control signal to allow the focus-lens group 203 to perform a wobbling motion.

Similar processes performed on the focus-lens group 202 can be performed on the focus-lens group 203, and vice versa.

### 3. Modification

The foregoing has described the embodiments of the present disclosure; however, the disclosure should not be limited to the foregoing embodiments and various modifications may be made.

Although the detection area is set at the center of an image in the above-described embodiment, the detection area can be located at other places in accordance with the position and size to be focused in an imaging area.

In addition to the phase of the wobbling control signal corrected in the aforementioned embodiments, amplitude of the wobbling control signal can be adjusted to match the target drive motion. For instance, the same amplitude control as that performed on the focus-lens group 202 can be performed on the focus-lens group 203 in the second embodiment.

When a plurality of drive motion histories of the focus-lens groups are compared, the comparison can be made only for the center of the stop period of wobbling or every time a drive motion history is obtained. Comparing a drive motion history of a focus-lens group with a target drive motion is also made in the same manner.

A target drive motion in accordance with exposure time (shutter speed) may be stored in the EEPROM or the like. The target drive can be configured to be retrieved in accordance with the exposure time.

Furthermore, the present disclosure can be implemented by, in addition to a device, a method, a program and a recording medium.

It should be noted that the configurations and processes of the above embodiments and modification can be combined as appropriate insofar as no technical contradiction arises. The order of the processes in the procedure described as examples can be changed as appropriate within a scope with no technical contradiction.

The present disclosure is applicable to a so-called cloud system in which the processes shown as examples are distributed and performed on a plurality of devices. The present disclosure can be implemented by a system capable of performing the processes described as examples in the embodiments and modification or a device capable of performing at least a part of the processes described as examples.

The present disclosure may have the following configurations.

[1] A focus control device including:

a first focus-lens group;

a second focus-lens group;

a wobbling control unit that generates a first wobbling control signal used to control a wobbling motion of the first focus-lens group and generates a second wobbling control signal used to control a wobbling motion of the second focus-lens group; and

a phase control unit that controls the phase of the first wobbling control signal and the phase of the second wobbling control signal, wherein

the phase control unit

corrects the phase of the first wobbling control signal to cause the first focus-lens group to make a first target wobbling motion and

corrects the phase of the second wobbling control signal to cause the second focus-lens group to make a second target wobbling motion.

[2] The focus control device as recited in [1], wherein

a detection area is set in order to perform a focus evaluation on an image signal captured by an image pickup unit, and

the first target wobbling motion and the second target wobbling motion are motions set such that the centers of periods of sections of the wobbling motions substantially coincide with an exposure period of a central pixel in the detection area.

[3] The focus control device as recited in [1] or [2], wherein

the phase control unit

determines a wobbling motion of the first focus-lens group based on a first present wobbling control signal, and corrects the phase of the first wobbling control signal based on the comparison result between the determined wobbling motion and the first wobbling motion and

determines a wobbling motion of the second focus-lens group based on a second present wobbling control signal, and corrects the phase of the second wobbling control signal based on the comparison result between the determined wobbling motion and the second wobbling motion.

[4] The focus control device as recited in [3], wherein

the phase control unit

compares the center of a period of a section of the determined wobbling motion with the center of a period of the section of the first wobbling motion and

compares the center of a period of a section of the determined wobbling motion with the center of a period of the section of the second wobbling motion.

[5] A method for controlling focus in a focus control device, including:

generating a first wobbling control signal used to control a wobbling motion of a first focus-lens group;

generating a second wobbling control signal used to control a wobbling motion of a second focus-lens group;

controlling the phase of the first wobbling control signal and the phase of the second wobbling control signal;

correcting the phase of the first wobbling control signal to cause the first focus-lens group to make a first target wobbling motion, and

correcting the phase of the second wobbling control signal to cause the second focus-lens group to make a second target wobbling motion.

[6] An image pickup apparatus including:

an image pickup unit;

a first focus-lens group;

a second focus-lens group;

a wobbling control unit that generates a first wobbling control signal used to control a wobbling motion of the first focus-lens group and generates a second wobbling control signal used to control a wobbling motion of the second focus-lens group; and

a phase control unit that controls the phase of the first wobbling control signal and the phase of the second wobbling control signal, wherein

a detection area is set in order to perform a focus evaluation on an image signal captured by an image pickup unit, and

the phase control unit

corrects the phase of the first wobbling control signal to cause the first focus-lens group to make a first target wobbling motion and

corrects the phase of the second wobbling control signal to cause the second focus-lens group to make a second target wobbling motion, and

the first target wobbling motion and the second target wobbling motion are motions set such that centers of priods of sections of the wobbling motions substantially coincides with an exposure period of a central pixel in the detection area.

[7] A focus control device including:

a first focus-lens group;

a second focus-lens group;

a wobbling control unit that generates a first wobbling control signal used to control a wobbling motion of the first focus-lens group and generates a second wobbling control signal used to control a wobbling motion of the second focus-lens group; and

a phase control unit that controls the phase of the first wobbling control signal and the phase of the second wobbling control signal, wherein

the phase control unit

corrects the phase of the first wobbling control signal to cause the first focus-lens group to make a first target wobbling motion and

corrects the phase of the second wobbling control signal for the second focus-lens group so as to cause the second focus-lens group to follow the wobbling motion of the first focus-lens group based on the first wobbling control signal.

[8] A method for controlling focus in a focus control device, including:

generating a first wobbling control signal used to control a wobbling motion of a first focus-lens group;

generating a second wobbling control signal used to control a wobbling motion of a second focus-lens group;

controlling the phase of the first wobbling control signal and the phase of the second wobbling control signal;

correcting the phase of the first wobbling control signal to cause the first focus-lens group to make a first target wobbling motion,

correcting the phase of the second wobbling control signal for the second focus-lens group so as to cause the second focus-lens group to follow the wobbling motion of the first focus-lens group based on the first wobbling control signal.

The present disclosure contains subject matter related to that disclosed in Japanese Priority Patent Application JP 2012-202470 filed in the Japan Patent Office on Sep. 14, 2012, the entire contents of which are hereby incorporated by reference.

What is claimed is:

1. A focus control device comprising:
a first focus-lens group;
a second focus-lens group;
a wobbling control unit that generates a first wobbling control signal used to control a wobbling motion of the first focus-lens group and generates a second wobbling control signal used to control a wobbling motion of the second focus-lens group; and
a phase control unit that controls the phase of the first wobbling control signal and the phase of the second wobbling control signal, wherein
the phase control unit
corrects the phase of the first wobbling control signal to cause the first focus-lens group to make a first target wobbling motion and
corrects the phase of the second wobbling control signal to cause the second focus-lens group to make a second target wobbling motion.

2. The focus control device according to claim 1, wherein
a detection area is set in order to perform a focus evaluation on an image signal captured by an image pickup unit, and
the first target wobbling motion and the second target wobbling motion are motions set such that centers of periods of sections of the wobbling motions substantially coincide with an exposure period of a central pixel in the detection area.

3. The focus control device according to claim 1, wherein
the phase control unit
determines a wobbling motion of the first focus-lens group based on a first present wobbling control signal and corrects the phase of the first wobbling control signal based on the comparison result between the determined wobbling motion and the first wobbling motion and
determines a wobbling motion of the second focus-lens group based on a second present wobbling control signal and corrects the phase of the second wobbling control signal based on the comparison result between the determined wobbling motion and the second wobbling motion.

4. The focus control device according to claim 3, wherein
the phase control unit
compares the center of a period of a section of the determined wobbling motion with the center of a period of the section of the first wobbling motion and
compares the center of a period of a section of the determined wobbling motion with the center of a period of the section of the second wobbling motion.

5. A method for controlling focus in a focus control device, comprising:
generating a first wobbling control signal used to control a wobbling motion of a first focus-lens group;
generating a second wobbling control signal used to control a wobbling motion of a second focus-lens group;
controlling the phase of the first wobbling control signal and the phase of the second wobbling control signal;
correcting the phase of the first wobbling control signal to cause the first focus-lens group to make a first target wobbling motion; and
correcting the phase of the second wobbling control signal to cause the second focus-lens group to make a second target wobbling motion.

6. An image pickup apparatus comprising:
an image pickup unit;
a first focus-lens group;
a second focus-lens group;
a wobbling control unit that generates a first wobbling control signal used to control a wobbling motion of the first focus-lens group and generates a second wobbling control signal used to control a wobbling motion of the second focus-lens group; and
a phase control unit that controls the phase of the first wobbling control signal and the phase of the second wobbling control signal, wherein
a detection area is set in order to perform a focus evaluation on an image signal captured by an image pickup unit,
the phase control unit
corrects the phase of the first wobbling control signal to cause the first focus-lens group to make a first target wobbling motion and
corrects the phase of the second wobbling control signal to cause the second focus-lens group to make a second target wobbling motion, and
the first target wobbling motion and the second target wobbling motion are motions set such that centers of periods of sections of the wobbling motions substantially coincide with an exposure period of a central pixel in the detection area.

7. A focus control device comprising:
a first focus-lens group;
a second focus-lens group;
a wobbling control unit that generates a first wobbling control signal used to control a wobbling motion of the first focus-lens group and generates a second wobbling control signal used to control a wobbling motion of the second focus-lens group; and
a phase control unit that controls the phase of the first wobbling control signal and the phase of the second wobbling control signal, wherein
the phase control unit
corrects the phase of the first wobbling control signal to cause the first focus-lens group to make a first target wobbling motion and
corrects the phase of the second wobbling control signal for the second focus-lens group so as to cause the second focus-lens group to follow the wobbling motion of the first focus-lens group based on the first wobbling control signal.

8. A method for controlling focus in a focus control device, comprising:
generating a first wobbling control signal used to control a wobbling motion of a first focus-lens group;
generating a second wobbling control signal used to control a wobbling motion of a second focus-lens group;
controlling the phase of the first wobbling control signal and the phase of the second wobbling control signal;
correcting the phase of the first wobbling control signal to cause the first focus-lens group to make a first target wobbling motion; and
correcting the phase of the second wobbling control signal for the second focus-lens group so as to cause the second focus-lens group to follow the wobbling motion of the first focus-lens group based on the first wobbling control signal.
